(19) United States
(12) Patent Application Publication
(10) Pub. No.: US 2025/0092287 A1
(43) Pub. Date: Mar. 20, 2025

(54) WEB-SHAPED ADHESIVE COMPOUND CONTAINING A POLYURETHANE- AND/OR SILICONE-BASED FILLER

(71) Applicant: TESA SE, Norderstedt (DE)

(72) Inventors: Anika PETERSEN, Norderstedt (DE); Ann-Kathrin NÄGELE, Norderstedt (DE); Hans-Peter GRAEF, Norderstedt (DE)

(73) Assignee: TESA SE, Norderstedt (DE)

(21) Appl. No.: 18/292,249

(22) PCT Filed: Jul. 22, 2022
(86) PCT No.: PCT/EP2022/070703

§ 371 Date: Jan. 25, 2024

(30) Foreign Application Priority Data
Jul. 26, 2021 (DE) 10 2021 208 045.6

(51) Int. Cl. C09J 7/38; C09J 133/10

(52) U.S. Cl. CPC C09J 7/385; C09J 133/10; C09J 2301/20; C09J 2301/302; C09J 2301/408; C09J 2301/414; C09J 2433/00; C09J 2453/00; C09J 2475/00; C09J 2483/00

(57) ABSTRACT

The present invention relates to a web-shaped adhesive compound which contains at least one poly(meth)acrylate and optionally at least one synthetic rubber; and at least one polyurethane- and/or silicone-based filler. The invention also relates to a process for preparing such an adhesive compound and to the use thereof. The invention further relates to the use of polyurethane- and/or silicone-based fillers for increasing the adhesive power of adhesive compounds containing at least one poly(meth)acrylate and optionally at least one synthetic rubber and/or for increasing the shock performance of such adhesive compounds with respect to adhesive compounds which do not contain any polyurethane- and/or silicone-based filler.

The present application is a 371 of International Patent Application No. PCT/EP2022/070703, filed Jul. 22, 2022, which claims priority of German Patent Application No. 10 2021 208 045.6, filed Jul. 26, 2021, the entire contents of which patent applications are hereby incorporated herein by reference.

The present invention relates to a web-form pressure sensitive adhesive (PSA) compound comprising
at least one poly(meth)acrylate and optionally at least one synthetic rubber; and
at least one polyurethane- and/or silicone-based filler.

Other subjects of the invention are a process for preparing such a PSA compound and the use thereof. The invention further relates to the use of a polyurethane- and/or silicone-based filler for boosting the bonding performance of PSA compounds comprising at least one poly(meth)acrylate and optionally at least one synthetic rubber and/or for boosting the shock performance of such PSA compounds relative to PSA compounds comprising no polyurethane- and/or silicone-based filler.

PSAs, based in particular on acrylate/synthetic rubber (SBC) blends, as described for example in EP 2832811 A1, have already been used for some considerable time in the bonding of various materials. Advantages attaching to the combination of acrylate matrix and SBC phase in dispersion therein include the good shock performance, with the SBC phase acting as a shock modifier.

A further established feature in the field of these PSA compounds is that of microballoon foaming, with which oftentimes an additional boost to the bonding performance under high-frequency load has been achieved.

This same microballoon foaming leads at the same time to a certain limitation, as the hollow microspheres create a kind of predetermined breakage point in the product, at which the adhesive tape undergoes cohesive splitting (also called foam split).

If in turn the microballoon foaming is omitted, then oftentimes there is an adhesive failure under the corresponding test conditions, leading fundamentally to relatively low measurement results that fluctuate sharply. In this case, adhesive bonding is performed at the premises of the customer with an application of primer beforehand, so facilitating the cohesive splitting even for unfoamed products.

The absence of the microballoons also leads to a greater internal strength on cohesive fracture, and hence to an increased energy requirement for the parting of the bond under shock load. The adhesive tape is therefore able to absorb more energy before the bond fails.

An object of the present invention, therefore, was to provide a PSA compound whose shock loading is at least similar to that of microballoon-foamed PSA compounds but which additionally does not possess the advantages described above for these PSA compounds.

The inventors of the present invention surprisingly found that the microballoons in the adhesive compounds may be replaced by fillers based on polyurethane or on silicone in order to achieve this object. It was found more particularly that the use of polyurethane-based or silicone-based fillers, especially those in spherical form (beads), on condition of the cohesive splitting, results in a further boost to shock performance. Colored fillers are preferably employed, which also improve the opacity of the adhesive compounds.

A first and general subject of the invention is a web-form pressure sensitive adhesive (PSA) compound comprising
at least one poly(meth)acrylate; and
at least one polyurethane- and/or silicone-based filler.

### BRIEF DESCRIPTION OF THE DRAWING

The invention will now be described in greater detail with reference to the drawing, wherein:

FIG. 1 is a graph depicting heat flow as a function of temperature.

What is understood by a PSA or PSA compound in accordance with the invention, as usual in general parlance, is a substance which, at least at room temperature, is permanently tacky and adhesive. The characteristic feature of a PSA is that it can be applied to a substrate by pressure and remains stuck thereon, without specific definition of the pressure to be expended and the duration of action of this pressure. In general, but fundamentally depending on the exact nature of the PSA and the substrate, the temperature and air humidity, the action of a brief minimal pressure not extending beyond gentle contact for a brief moment is sufficient to achieve the adhesion effect; in other cases, a longer duration of action at a higher pressure may also be necessary.

PSA compounds have particular, characteristic viscoelastic properties that lead to the sustained tackiness and adhesiveness. It is characteristic of these compounds that, if they are mechanically deformed, there are both viscous flow processes and buildup of elastic resilience forces. The two processes are in a particular ratio to one another with regard to their respective proportion, depending both on the exact composition, the structure and the level of crosslinking of the PSA compound and on the speed and duration of the deformation, and also on the temperature.

The viscous flow component is needed for achievement of adhesion. Only the viscous components, frequently caused by macromolecules having relatively high mobility, enable good wetting and good flow to the substrate to be bonded. A high proportion of viscous flow leads to high pressure sensitive adhesiveness (also referred to as tack or surface tack) and hence often also to a high adhesion. Highly crosslinked systems, crystalline polymers or polymers that have solidified in vitreous form, are generally not tacky or at least only slightly tacky, for lack of free-flowing components.

The elastic resilience force components are needed for the achievement of cohesion. These forces are caused, for example, by very long-chain and highly entangled macromolecules, and by physically or chemically crosslinked macromolecules, and enable transfer of the forces that attack an adhesive bond. They have the effect that an adhesive bond can withstand a sustained stress that acts thereon, for example in the form of a sustained shear stress, to a sufficient degree over a prolonged period of time.

For more exact description and quantification of the degree of the elastic and viscous components, and of the ratio of the components to one another, the parameters of storage modulus (G′) and loss modulus (G″) that are determinable by means of dynamic mechanical analysis (DMA) are cited. G′ is a measure of the elastic component, G″ a measure of the viscous component of a substance. The two parameters are dependent on the deformation frequency and the temperature.

The parameters can be ascertained with the aid of a rheometer. The material to be examined is subjected here, for example in a plate-plate arrangement, to a sinusoidally oscillating shear stress. In shear stress-controlled instruments, deformation as a function of time and the offset in this deformation over time with respect to the introduction of shear stress are measured. This offset overtime is referred to as phase angle δ.

Storage modulus G′ is defined as follows: G′=(τ/γ)·cos(δ) (τ=shear stress, γ=deformation, δ=phase angle=phase shift between shear stress vector and deformation vector). The definition of loss modulus G″ is: G″=(τ/γ)·sin(δ) (τ=shear stress, γ=deformation, δ=phase angle=phase shift between shear stress vector and deformation vector).

A compound is considered to be a PSA compound especially and is defined as such in the invention especially when, at 23° C., in the deformation frequency range from 10⁰ to 10¹ rad/sec, both G′ and G″ are at least partly within the range from 10³ to 10⁷ Pa.

A “poly(meth)acrylate” is understood to mean a polymer obtainable by radical polymerization of acrylic monomers and/or methacrylic monomers and optionally further copolymerizable monomers. More particularly, a “poly(meth)acrylate” is understood to mean a polymer having a monomer basis consisting to an extent of at least 50% by weight of acrylic acid, methacrylic acid, acrylic esters and/or methacrylic esters, where acrylic esters and/or methacrylic esters are present at least in part, preferably to an extent of at least 30% by weight, based on the overall monomer basis of the polymer in question.

The PSA compound of the invention preferably comprises poly(meth)acrylate at in total 40 to 70% by weight, more preferably at in total 45 to 60% by weight, based in each case on the total weight of the PSA compound. It is possible for a (single) poly(meth)acrylate or multiple poly(meth)acrylates to be present.

The glass transition temperature of the poly(meth)acrylate in the PSA compound of the invention is preferably <0° C., more preferably between −5 and −50° C. The glass transition temperature of polymers or of polymer blocks in block copolymers is determined in accordance with the invention by means of dynamic scanning calorimetry (DSC). For this purpose, around 5 mg of an untreated polymer sample is weighed into an aluminum boat (volume 25 μl) and closed with a perforated lid. The measurement is made using a DSC 204 F1 from Netzsch. A nitrogen atmosphere is employed for inertization. The sample is first cooled down to −150° C., then heated up to +150° C. at a heating rate of 10 K/min and cooled down again to −150° C. The subsequent second heating curve is run again at 10 K/min and the change in heat capacity is recorded. Glass transitions are recognized as steps in the thermogram.

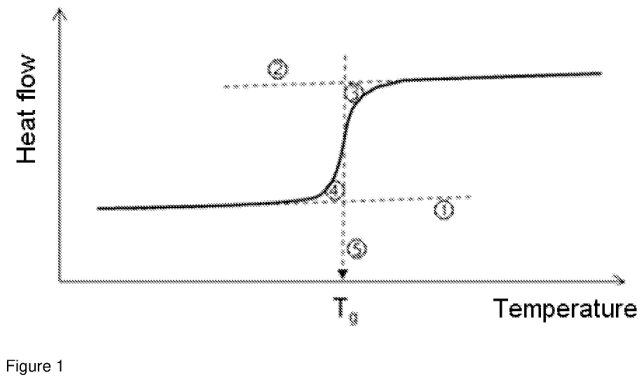

The glass transition temperature is obtained as follows (see FIG. 1):

The respectively linear region of the measurement curve before and after the step is extended in the direction of rising temperatures (region before the step) or falling temperatures (region after the step) (tangents \textcircled{1} and \textcircled{2}). In the region of the step, a line of best fit \textcircled{5} is run parallel to the ordinate such that it intersects with both tangents, specifically in such a way as to form two equal areas \textcircled{3} and \textcircled{4} (between the respective tangent, the line of best fit and the measurement curve). The point of intersection of the line of best fit thus positioned with the measurement curve gives the glass transition temperature.

The poly(meth)acrylate in the PSA compound of the invention preferably comprises at least one proportionally copolymerized functional monomer which is more preferably reactive with epoxy groups to form a covalent bond. Most preferably, the proportionally copolymerized functional monomer which is more preferably reactive with epoxy groups to form a covalent bond contains at least one functional group selected from the group consisting of carboxylic acid groups, sulfonic acid groups, phosphonic acid groups, hydroxy groups, acid anhydride groups, epoxy groups and amino groups; it especially contains at least one carboxylic acid group. Extremely preferably, the poly(meth)acrylate in the PSA compound of the invention contains proportionally copolymerized acrylic acid and/or methacrylic acid. All the groups mentioned have reactivity with epoxy groups, which means that the poly(meth)acrylate is advantageously amenable to thermal crosslinking with introduced epoxides.

The poly(meth)acrylate in the PSA compound of the invention may preferably be based on the following monomer composition:
a) at least one acrylic ester and/or methacrylic ester of the following formula (1)

CH₂═C(R^{I})(COOR^{II}) (1)
in which R^{I}═H or CH₃ and R^{II} is an alkyl radical having 4 to 18 C atoms;
b) at least one olefinically unsaturated monomer having at least one functional group selected from the group consisting of carboxylic acid groups, sulfonic acid groups, phosphonic acid groups, hydroxy groups, acid anhydride groups, epoxy groups and amino groups;
c) optionally further acrylic esters and/or methacrylic esters and/or olefinically unsaturated monomers copolymerizable with component (a).

It is particularly advantageous to choose the monomers of component a) with a proportion of 45 to 99% by weight, the monomers of component b) with a proportion of 1 to 15% by weight and the monomers of component c) with a proportion of 0 to 40% by weight, where the figures are based on the monomer mixture for the base polymer without additions of any additives such as resins etc.

The monomers of component a) are generally plasticizing, comparatively nonpolar monomers. More preferably, R^{II} in the monomers a) is an alkyl radical having 4 to 10 C atoms or 2-propylheptyl acrylate or 2-propylheptyl methacrylate. The monomers of the formula (1) are especially selected from the group consisting of n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate, 2-ethylhexyl methacrylate, 2-propylheptyl acrylate and 2-propylheptyl methacrylate.

The monomers of component b) are more preferably selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

Illustrative monomers of component c) are:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxy diethylene glycol methacrylate, ethoxy triethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethyl-aminopropylacrylamide, dimethylaminopropylmethacrylamide, N-(1-methylundecyl)-acrylamide, N-(n-butoxymethyl)acrylamide, N-(butoxymethyl)methacrylamide, N-(ethoxymethyl)acrylamide, N-(n-octadecyl)acrylamide; N,N-dialkyl-substituted amides, for example N,N-dimethylacrylamide and N,N-dimethylmethacrylamide; N-benzylacrylamide, N-isopropylacrylamide, N-tert-butylacrylamide, N-tert-octylacrylamide, N-methylolacrylamide, N-methylolmethacrylamide, acrylonitrile, methacrylonitrile; vinyl ethers such as vinyl methyl ether, ethyl vinyl ether, vinyl isobutyl ether; vinyl esters such as vinyl acetate; vinyl halides, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene; macromonomers such as 2-polystyreneethyl methacrylate (weight-average molecular weight Mw, determined by GPC, of 4000 to 13 000 g/mol), poly(methyl methacrylate)ethyl methacrylate (Mw of 2000 to 8000 g/mol).

Monomers of component c) may advantageously also be chosen such that they contain functional groups that assist subsequent radiochemical crosslinking (for example by electron beams, UV). Suitable copolymerizable photoinitiators are, for example, benzoin acrylate and acrylate-functionalized benzophenone derivatives. Monomers that assist crosslinking by electron bombardment are, for example, tetrahydrofurfuryl acrylate, N-tert-butylacrylamide and allyl acrylate.

The preparation of the poly(meth)acrylates is preferably accomplished by conventional radical polymerizations or controlled radical polymerizations. The poly(meth)acrylates can be prepared by copolymerization of the monomers using customary polymerization initiators and optionally chain transfer agents, by polymerization at the customary temperatures in bulk, in emulsion, for example in water or liquid hydrocarbons, or in solution.

The poly(meth)acrylates are preferably prepared by copolymerizing the monomers in solvents, more preferably in solvents having a boiling range of 50 to 150° C., especially of 60 to 120° C., using 0.01 to 5% by weight, especially 0.1 to 2% by weight, based in each case on the total weight of the monomers, of polymerization initiators.

All customary initiators are suitable in principle. Examples of radical sources are peroxides, hydroperoxides and azo compounds, for example dibenzoyl peroxide, cumene hydroperoxide, cyclohexanone peroxide, di-t-butyl peroxide, cyclohexylsulfonylacetyl peroxide, diisopropyl percarbonate, t-butyl peroctoate and benzopinacol. Preferred radical initiators are 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont).

Preferred solvents for the preparation of the poly(meth)acrylates are alcohols such as methanol, ethanol, n- and isopropanol, n- and isobutanol, especially isopropanol and/or isobutanol; hydrocarbons such as toluene and especially benzines with a boiling range from 60 to 120° C.; ketones, especially acetone, methyl ethyl ketone, methyl isobutyl ketone, esters such as ethyl acetate, and mixtures of the aforementioned solvents. Particularly preferred solvents are mixtures containing isopropanol in amounts of 2 to 15% by weight, especially of 3 to 10% by weight, based in each case on the solvent mixture used.

The preparation (polymerization) of the poly(meth)acrylates is preferably followed by a concentration step, and the further processing of the poly(meth)acrylates is essentially solvent-free. The concentration of the polymer can be accomplished in the absence of crosslinker and accelerator substances. But it is also possible to add one of these classes of compound to the polymer even before the concentration, such that the concentration is then performed in the presence of this/these substance(s).

After the concentration step, the polymers can be transferred to a compounder. The concentration and the compounding may optionally also take place in the same reactor.

The weight-average molecular weights M_{w} of the polyacrylates are preferably within a range from 20 000 to 2 000 000 g/mol; very preferably within a range from 100 000 to 1 500 000 g/mol, exceptionally preferably within a range from 150 000 to 1 000 000 g/mol. For this purpose, it may be advantageous to conduct the polymerization in the presence of suitable polymerization chain transfer agents such as thiols, halogen compounds and/or alcohols in order to establish the desired average molecular weight.

The number-average molar mass Mₙ and weight-average molar mass M_{w} FIGURES in this document relate to determination by gel permeation chromatography (GPC), which is known per se. The determination is made on a 100 μl clear-filtered sample (sample concentration 4 g/l). The eluent used is tetrahydrofuran with 0.1% by volume of trifluoroacetic acid. The measurement is made at 25° C.

The guard column used is a column of the PSS-SDV type, 5 μm, 10³ Å, 8.0 mm*50 mm (FIGURES here and hereinafter in the sequence: type, particle size, porosity, internal diameter length; 1 Å=10⁻¹⁰ m). Separation is accomplished using a combination of columns of the PSS-SDV type, 5 μm, 10³ Å, and 10⁵ Å and 10⁶ Å, each with 8.0 mm*300 mm (columns from Polymer Standards Service; detection by means of Shodex RI71 differential refractometer). The flow rate is 1.0 ml per minute. Calibration is performed using the commercially available ReadyCal® kit Poly(styrene) high from PSS Polymer Standards Service GmbH, Mainz. The values obtained are converted using the Mark-Houwink parameters K and alpha universally into polymethyl methacrylate (PMMA) and so the data are reported in PMMA mass equivalents.

The poly(meth)acrylates preferably have a K value of 30 to 90, more preferably of 40 to 70, measured in toluene (1% solution, 21° C.). Fikentscher's K value is a measure of the molecular weight and the viscosity of polymers.

The principle of the method is based on the determination of the relative solution viscosity by capillary viscometry. For this purpose, the test substance is dissolved in toluene by shaking for 30 minutes, so as to obtain a 1% solution. In a Vogel-Ossag viscometer, at 25° C., the flow time is measured and this is used to determine the relative viscosity of the sample solution with respect to the viscosity of the pure solvent. According to Fikentscher [P. E. Hinkamp, Polymer, 1967, 8, 381], it is possible to read off the K value from tables (K=1000 k).

The poly(meth)acrylate in the PSA compound of the invention preferably has a polydispersity PD<4 and hence a relatively narrow molecular weight distribution. Compounds based thereon, in spite of a relatively low molecular weight, after crosslinking have particularly good shear strength. Moreover, the relatively low polydispersity enables easier processing from the melt since the flow viscosity is lower compared to a poly(meth)acrylate of broader distribution with largely the same application properties. Poly(meth)acrylates having a narrow distribution can advantageously be prepared by anionic polymerization or by controlled radical polymerization methods, the latter being of particular good suitability. It is also possible to prepare corresponding poly(meth)acrylates via N-oxyls. In addition, it is advantageously possible to use atom transfer radical polymerization (ATRP) for synthesis of narrow-distribution poly(meth)acrylates, preferably using monofunctional or difunctional, secondary or tertiary halides as initiator, and complexes of Cu, Ni, Fe, Pd, Pt, Ru, Os, Rh, Co, Ir, Ag or Au for abstraction of the halides. RAFT polymerization is also suitable.

The poly(meth)acrylates in the PSA compound of the invention are preferably crosslinked by linkage reactions—especially in the form of addition or substitution reactions—of functional groups present therein with thermal crosslinkers. It is possible to use any thermal crosslinkers which
both ensure a sufficiently long processing time, such that there is no gelation during the processing operation, especially the extrusion operation,
and also lead to rapid post-crosslinking of the polymer to the desired level of crosslinking at lower temperatures than the processing temperature, especially at room temperature.

One possible example are polymers containing a combination of carboxy, amino and/or hydroxy groups, and as crosslinkers isocyanates, especially aliphatic or blocked isocyanates, examples being trimerized isocyanates deactivated with amines. Suitable isocyanates are, in particular, trimerized derivatives of MDI [4,4-methylenedi(phenyl isocyanate)], HDI [hexamethylene diisocyanate, hexylene 1,6-diisocyanate] and IPDI [isophorone diisocyanate, 5-isocyanato-1-isocyanatomethyl-1,3,3-trimethylcyclohexane], examples being the products Desmodur® N3600 and XP2410 (each from Bayer AG: aliphatic polyisocyanates, low-viscosity HDI trimers). Likewise suitable is the surface-deactivated dispersion of micronized, trimerized IPDI BUEJ 339®, now HF9® (Bayer AG).

Preference is given to using thermal crosslinkers at 0.1 to 5% by weight, especially at 0.2 to 1% by weight, based on the total amount of the polymer to be crosslinked.

Crosslinking via complexing agents, also referred to as chelates, is also possible. An example of a preferred complexing agent is aluminum acetylacetonate.

The poly(meth)acrylates in the PSA compound of the invention are preferably crosslinked by means of one or more epoxides or by means of one or more substances containing epoxy groups. The substances containing epoxy groups are more particularly polyfunctional epoxides, i.e., those with at least two epoxy groups; the overall result is accordingly indirect linkage of the units of the poly(meth)acrylates that bear the functional groups. The substances containing epoxy groups may be either aromatic or aliphatic compounds.

Outstandingly suitable polyfunctional epoxides are oligomers of epichlorohydrin, epoxy ethers of polyhydric alcohols, especially of ethylene glycol, propylene glycol and butylene glycol, polyglycols, thiodiglycols, glycerol, pentaerythritol, sorbitol, polyvinyl alcohol, polyallyl alcohol and the like; epoxy ethers of polyhydric phenols, especially of resorcinol, hydroquinone, bis(4-hydroxyphenyl)-methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)phenylmethane, bis(4-hydroxyphenyl)diphenylmethane, bis(4-hydroxyphenyl)-4′-methylphenyl)methane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxyphenyl)-cyclohexylmethane, 4,4′-dihydroxybiphenyl, 2,2′-dihydroxybiphenyl, 4,4′-dihydroxydiphenyl sulfone and the hydroxyethyl ethers thereof; phenol-formaldehyde condensation products such as phenol alcohols and phenol-aldehyde resins; S- and N-containing epoxides, for example N,N-diglycidylaniline and N,N′-dimethyldiglycidyl-4,4-diaminodiphenylmethane; and epoxides that have been prepared by customary methods from polyunsaturated carboxylic acids or monounsaturated carboxylic esters of unsaturated alcohols; glycidyl esters, and polyglycidyl esters, which can be obtained by polymerization or copolymerization of glycidyl esters of unsaturated acids or from other acidic compounds, for example from cyanuric acid, diglycidyl sulfide or cyclic trimethylene trisulfone or derivatives thereof.

Examples of very suitable ethers are butane-1,4-diol diglycidyl ether, polyglycerol-3 glycidyl ether, cyclohexanedimethanol diglycidyl ether, glycerol triglycidyl ether, neopentyl glycol diglycidyl ether, pentaerythritol tetraglycidyl ether, hexane-1,6-diol diglycidyl ether, polypropylene glycol diglycidyl ether, trimethylolpropane triglycidyl ether, pentaerythritol tetraglycidyl ether, bisphenol A diglycidyl ether and bisphenol F diglycidyl ether.

Other preferred epoxides are cycloaliphatic epoxides such as 3,4-epoxycyclohexylmethyl 3,4-epoxycyclohexanecarboxylate (UVACure1500).

More preferably, the poly(meth)acrylates are crosslinked by means of a crosslinker-accelerator system (“crosslinking system”), in order to obtain better control over the processing time, crosslinking kinetics and degree of crosslinking. The crosslinker-accelerator system preferably comprises at least one substance containing epoxy groups as crosslinker, and at least one substance having accelerating action at a temperature below the melting temperature of the polymer to be crosslinked for crosslinking reactions by means of compounds containing epoxy groups as accelerator.

Accelerators used in accordance with the invention are more preferably amines. These should be regarded in a formal sense as substitution products of ammonia; in the formulas that follow, the substituents are represented by “R” and especially include alkyl and/or aryl radicals. Particular preference is given to using those amines that enter into only a low level of reactions, if any, with the polymers to be crosslinked.

In principle, accelerators chosen may be primary (NRH₂), secondary (NR₂H) or else tertiary amines (NR₃), and of course also those having multiple primary and/or secondary and/or tertiary amino groups. Particularly preferred accelerators are tertiary amines, for example triethylamine, triethylenediamine, benzyldimethylamine, dimethylaminomethylphenol, 2,4,6-tris(N,N-dimethylaminomethyl)phenol and N,N′-bis(3-(dimethylamino)propyl)urea. Further preferred accelerators are polyfunctional amines such as diamines, triamines and/or tetramines, for example diethylenetriamine, triethylenetetramine and trimethylhexamethylenediamine.

Further preferred accelerators are amino alcohols, especially secondary and/or tertiary amino alcohols, where, in the case of multiple amino functionalities per molecule, preferably at least one amino functionality and more preferably all amino functionalities are secondary and/or tertiary. Particularly preferred accelerators of this kind are triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butyl-ethanolamine, 2-[bis(2-hydroxyethyl)amino]-2-(hydroxymethyl)-1,3-propanediol, 1-[bis(2-hydroxyethyl)amino]-2-propanol, triisopropanolamine, 2-(dimethylamino)ethanol, 2-(diethylamino)ethanol, 2-(2-dimethylaminoethoxy)ethanol, N,N,N′-trimethyl-N′-hydroxyethyl bisaminoethyl ether, N,N,N′-trimethylaminoethylethanolamine and N,N,N′-trimethylaminopropylethanolamine.

Further suitable accelerators are pyridine, imidazoles, for example 2-methylimidazole, and 1,8-diazabicyclo[5.4.0]undec-7-ene. It is also possible to use cycloaliphatic polyamines as accelerators. Also suitable are phosphorus-based accelerators such as phosphines and/or phosphonium compounds, for example triphenylphosphine or tetraphenylphosphonium tetraphenylborate.

It is also possible to use quaternary ammonium compounds as accelerators; examples are tetrabutylammonium hydroxide, cetyltrimethylammonium bromide and benzalkonium chloride.

The PSA compound of the invention may further comprise at least one synthetic rubber; preferably, it comprises at least one synthetic rubber.

The PSA compound preferably comprises synthetic rubber at in total 15 to 50% by weight, more preferably at in total 20 to 40% by weight, based in each case on the total weight of the PSA compound. There may be one synthetic rubber or two or more synthetic rubbers comprised in the PSA compound of the invention.

The synthetic rubber in the PSA compound of the invention is preferably a block copolymer having a structure A-B, A-B-A, (A-B)ₙ, (A-B)ₙX or (A-B-A)ₙX,

in which
the blocks A independently of one another are a polymer formed by polymerization of at least one vinyl aromatic;
the blocks B independently of one another are a polymer formed by polymerization of conjugated dienes having 4 to 18 C atoms and/or isobutylene, or are a partially or fully hydrogenated derivative of such a polymer;
X is the radical of a coupling reagent or initiator, and
n is an integer ≥2.

In particular, all synthetic rubbers in the PSA compound of the invention are block copolymers having a structure as set out above. The PSA compound of the invention may therefore also comprise mixtures of different block copolymers having a structure as above.

The preferred synthetic rubbers, also referred to as vinyl aromatic block copolymers, therefore comprise one or more rubberlike blocks B (soft blocks) and one or more glasslike blocks A (hard blocks). The synthetic rubber in the PSA compound of the invention is more preferably a block copolymer having a structure A-B, A-B-A, (A-B)₃X or (A-B)₄X, where A, B and X have the definitions above. With very particular preference, all synthetic rubbers in the PSA compound of the invention are block copolymers having a structure A-B, A-B-A, (A-B)₃X or (A-B)₄X, where A, B and X have the definitions above. In particular, the synthetic rubber in the PSA compound of the invention is a mixture of block copolymers having a structure A-B, A-B-A, (A-B)₃X or (A-B)₄X, which preferably comprises at least diblock copolymers A-B and/or triblock copolymers A-B-A.

Block A is more particularly a glasslike block having a preferred glass transition temperature (Tg, DSC) which lies above room temperature. More preferably, the Tg of the glasslike block is at least 40° C., more particularly at least 60° C., very preferably at least 80° C., and most preferably at least 100° C. The proportion of vinyl aromatic blocks A among the entirety of the block copolymers is preferably 10 to 40% by weight, more preferably 20 to 33% by weight. Vinyl aromatics for the synthesis of block A comprise preferably styrene and α-methylstyrene. Block A may therefore take the form of a homopolymer or copolymer. Block A is more preferably a polystyrene.

Block B is more particularly a rubberlike block or soft block having a preferred Tg of less than room temperature. The Tg of the soft block is more preferably less than 0° C., more particularly less than −10° C., for example less than −40° C. and very preferably less than −60° C.

Preferred conjugated dienes as monomers for the soft block B are selected more particularly from the group consisting of butadiene, isoprene, ethylbutadiene, phenylbutadiene, piperylene, pentadiene, hexadiene, ethylhexadiene, dimethylbutadiene and the farnesene isomers and also any desired mixtures of these monomers. Block B as well may take the form of a homopolymer or a copolymer.

The conjugated dienes as monomers for the soft block B are more preferably selected from butadiene and isoprene. For example, the soft block B is a polyisoprene, a polybutadiene or a partially or fully hydrogenated derivative of one of these two polymers, such as, in particular, polybutylenebutadiene; or a polymer of a mixture of butadiene and isoprene. Very preferably, block B is a polybutadiene.

In the PSA compound of the invention, the synthetic rubber is preferably in dispersion in the poly(meth)acrylate. Preferably, therefore, poly(meth)acrylate and synthetic rubber are each homogeneous phases. The poly(meth)acrylates and synthetic rubbers comprised in the PSA compound are preferably chosen such that they are not miscible with one another to the point of homogeneity at 23° C. At least microscopically and at least at room temperature, accordingly, the PSA compound of the invention is preferably present in at least two-phase morphology. Poly(meth)acrylate(s) and synthetic rubber(s) are more preferably not homogeneously miscible with one another in a temperature range from 0° C. to 50° C., more particularly from −30° C. to 80° C., and so within these temperature ranges the PSA compound is present at least microscopically in at least two-phase form.

Components are defined for the purposes of this specification as “not homogeneously miscible with one another” when even after intermediate mixing, the formation of at least two stable phases is detectable physically and/or chemically, at least microscopically, with one phase being rich in one component and the second phase being rich in the other component. Presence of negligibly small amounts of one component in the other, without opposing development of the multiphase character, is considered insignificant in this regard. Hence the poly(meth)acrylate phase may contain small amounts of synthetic rubber, and/or the synthetic rubber phase may contain small amounts of poly(meth)acrylate component, as long as these amounts are not substantial amounts which influence the phase separation.

The phase separation may be realized in particular such that discrete regions (“domains”) which are rich in synthetic rubber—in other words are essentially formed of synthetic rubber—are present in a continuous matrix which is rich in poly(meth)acrylate—in other words is essentially formed of poly(meth)acrylate. One suitable system of analysis for a phase separation is, for example, scanning electron microscopy. Alternatively, phase separation may also be detectable, for example, by the different phases having two glass transition temperatures independent of one another in dynamic scanning calorimetry (DSC) or dynamic mechanical analysis (DMA). Phase separation is present according to the invention when it can clearly be shown by at least one of the analytical methods.

Within the synthetic rubber-rich domains, there may also be additional multiphasedness present as a fine structure, in which case the A blocks form one phase and the B blocks form a second phase.

A PSA compound of the invention preferably comprises 40-70% by weight of at least one poly(meth)acrylate and 15-50% by weight, based in each case on the total weight of the PSA compound, of at least one synthetic rubber.

The PSA compound of the invention comprises at least one polyurethane- and/or silicone-based filler. Generally all polyurethane- and silicone-based fillers that are known in the field are suitable.

Preferably, the at least one polyurethane-based filler comprises or consists of polyurethane beads and/or the at least one silicone-based filler comprises or consists of silicone beads. A bead is a very largely spherical particle. Aliphatic polyurethane beads are used more preferably. In one alternative embodiment, preference is given to using silicone beads which have both a rubber fraction and a resin fraction, referred to as hybrid silicone beads.

Suitable silicone-based fillers are for example disclosed in US 2008308225 A1 or available commercially from Shin-Etsu Chemical Co., Ltd. under the trade name KMP, especially KMP-601 or KMP-600.

Suitable polyurethane-based fillers are for example available commercially from Lamberti S.p.A. under the trade name Decosphaera®, especially Decosphaera® 15F.

In one embodiment, the beads have a mean particle size d(50) of 1 to 80 μm, preferably 1 to 30 μm, more preferably 1 to 25 or 10 to 30 μm or 10 to 20 μm, measured by means of DIN 66111:1989-02 or by laser diffraction according to ISO 13320:2020-01.

In one embodiment, the beads, especially polyurethane beads, have a bulk density of 300 to 800 g/L, preferably 500 to 800 g/L, measured by means of DIN EN 1097-3:1998-06.

In one embodiment, the at least one polyurethane- and/or silicone-based filler is comprised in the PSA compound at 0.1 to 10% by weight, preferably 2.5 to 7% by weight or 3 to 7% by weight, based on the total weight of the PSA compound. At fractions above 10% by weight, the adhesion may diminish.

A PSA compound of the invention preferably comprises at least one tackifier, which may also be termed a peel adhesion booster or tackifying resin, which is compatible in particular with the poly(meth)acrylate. A “tackifier” in accordance with the general understanding of the skilled person is an oligomeric or polymeric resin which increases the adhesion (the peel adhesion) of the PSA compound in comparison to the otherwise identical PSA compound containing no tackifier.

A “tackifier compatible with the poly(meth)acrylate” is a tackifier which alters the glass transition temperature of the system obtained after thorough mixing of poly(meth)acrylate and tackifier as compared with the pure poly(meth)acrylate, with only one Tg being assignable even to the mixture of poly(meth)acrylate and tackifier. A tackifier not compatible with the poly(meth)acrylate would lead to two Tgs in the system obtained after thorough mixing of poly(meth)acrylate and tackifier, one of which would be assignable to the poly(meth)acrylate and the other to the resin domains. The determination of the Tg in this context takes place calorimetrically by means of DSC (differential scanning calorimetry).

The tackifier compatible with the poly(meth)acrylate preferably has a DACP of less than 0° C., very preferably of at most −20° C., and/or preferably has an MMAP of less than 40° C., very preferably of at most 20° C. For determination of the DACP and MMAP values, reference is made to C. Donker, PSTC Annual Technical Seminar, Proceedings, pp. 149-164, May 2001.

With particular preference the tackifier compatible with the poly(meth)acrylate is a terpene-phenol resin, a (meth)acrylate resin or a rosin derivative, more particularly a (meth)acrylate resin. This makes it possible in particular to improve the adhesion on polar bond substrates. A PSA compound of the invention may also comprise mixtures of two or more tackifiers. Among the rosin derivatives, preference is given to rosin esters.

A PSA compound of the invention preferably comprises a tackifier compatible with the poly(meth)acrylate at in total 7 to 25% by weight, more preferably at in total 12 to 20% by weight, based in each case on the total weight of the PSA compound.

The tackifier compatible with the poly(meth)acrylate is preferably compatible or at least partially compatible with the synthetic rubber as well, particularly with the soft block B thereof, with the above definition of the term “compatible” being valid correspondingly. Polymer-resin compatibility is dependent on factors including the molar mass of the polymers and resins respectively. Compatibility is better when the molar masses are relatively low. For a given polymer, it may be possible that the low molecular mass constituents of the resin molar mass distribution are compatible with the polymer, while those of high molecular mass are not. This is an example of partial compatibility.

The weight ratio of poly(meth)acrylate to synthetic rubber in the PSA compound of the invention is preferably from 1:1 to 9:1, more particularly 2:1.

The PSA compound of the invention more preferably comprises
a) 45-60% by weight of at least one poly(meth)acrylate;
b) 20-40% by weight of at least one synthetic rubber; and
c) 7-25% by weight of at least one tackifier compatible in particular with the poly(meth)acrylate and/or synthetic rubber,
based in each case on the total weight of the PSA compound.

According to field of use and desired properties of the PSA compound of the invention, it may comprise further components and/or additives, in each case alone or in combination with one or more other additives or components. In particular, there may be further fillers included, different from the polyurethane- and/or silicone-based fillers. Preferred embodiments are described below.

Hence the PSA compound of the invention may comprise, for example, fillers in powder and granular form, including more particularly abrasive and reinforcing fillers, which are different from the polyurethane- and/or silicone-based filler; dyes; and pigments such as, for example, chalks (CaCO₃), titanium dioxide, zinc oxides and/or carbon blacks.

The PSA compound of the invention preferably comprises one or more chalk fillers. The PSA compound of the invention comprises chalk preferably at in total up to 20% by weight. With such fractions, there is virtually no alteration to significant technical adhesive properties such as the shear strength at room temperature and the instantaneous peel adhesion on steel and PE as a result of the addition of filler. Furthermore, various organic fillers may be included.

Suitable additives for the PSA compound of the invention are additionally—chosen independently of other additives—nonexpandable hollow polymer beads or solid polymer beads, which are different from the polyurethane- and/or silicone-based fillers; hollow glass beads, solid glass beads, hollow ceramic beads, solid ceramic beads and/or solid carbon beads (carbon microballoons).

The PSA compounds of the invention may, albeit not preferably, additionally comprise microballoons, more particularly in fractions of less than 1% by weight, based on the total weight of the PSA compound. Suitable illustrative microballoons are described for example in EP 2832811 A1. In one preferred embodiment there are no microballoons included.

The PSA compound of the invention may further comprise low-flammability fillers, for example ammonium polyphosphate; electrically conductive fillers, for example conductive carbon black, carbon fibers and/or silver-coated beads; thermally conductive materials, for example boron nitride, aluminum oxide, silicon carbide; ferromagnetic additives, for example iron(III) oxides; organic renewable raw materials, for example wood flour; organic and/or inorganic nanoparticles; fibers, compounding agents, aging inhibitors, light stabilizers and/or antiozonants.

The PSA compound of the invention optionally comprises one or more plasticizers. Examples of plasticizers which can be added include (meth)acrylate oligomers, phthalates, hydrocarbon oils, cyclohexanedicarboxylic esters, water-soluble plasticizers, plasticizing resins, phosphates or polyphosphates.

The PSA compound of the invention preferably comprises silicas, more preferably precipitated silica, more particularly precipitated silica surface-modified with dimethyldichlorosilane. With this additive it is possible advantageously to establish the thermal shear strength of the PSA compound.

Beyond the constituents recited so far, a PSA compound of the invention may comprise one or more hydrocarbon resins which are not compatible with the poly(meth)acrylate. Hydrocarbon resins of this kind, which are likewise tackifiers, comprise preferably hydrogenated polymers of dicyclopentadiene; unhydrogenated or partially, selectively or completely hydrogenated hydrocarbon resins based on C5, C5/C9 or C9 monomer streams, and polyterpene resins based on α-pinene and/or on ß-pinene and/or on δ-limonene. The hydrocarbon resins preferably have a DACP of at least 0° C., very preferably of at least 20° C., and/or preferably an MMAP of at least 40° C., very preferably of at least 60° C. For determination of DACP and MMAP values, reference is made to C. Donker, PSTC Annual Technical Seminar, Proceedings, pp. 149-164, May 2001. The aforesaid hydrocarbon resins may be included either individually or in a mixture in the PSA compound. Particularly preferred hydrocarbon resins are polyterpene resins based on α-pinene and/or on ß-pinene and/or on δ-limonene.

The density of a PSA compound of the invention is preferably at least 800 kg/m³, preferably at least 900 kg/m³, more preferably at least 1000 kg/m³. The PSA compound of the invention may preferably have a density of 800 to 1200 kg/m³, more preferably 900 to 1200 kg/m³, most preferably of 1000 to 1200 kg/m³.

The thickness of a web-form PSA compound of the invention is preferably 50 to 1500 μm, more preferably 70 to 1200 μm, more particularly 100 to 800 μm, for example 150 μm to 500 μm or 200 μm to 400 μm.

A further subject of the invention is a process for preparing a web-form PSA compound according to the present invention, which comprises
a) preparing a PSA compound comprising at least one poly(meth)acrylate and optionally at least one synthetic rubber and also at least one polyurethane- and/or silicone-based filler; and
b) shaping the PSA compound to the web in a calender nip,
where the PSA compound is guided through the calender nip such that a bank is formed ahead of the calender nip, and the temperature of the PSA compound in the bank
   is at least 5 K more than the temperature of the PSA compound immediately after its preparation.

The poly(meth)acrylate and the synthetic rubber and also the polyurethane- and/or silicone-based filler in the process of the invention are subject to the statements already made when describing the PSA compound of the invention.

The process of the invention for preparing a web-form PSA compound is preferably a continuous process.

Fundamentally, the preparation of the PSA compound up to its shaping to the web in the calender nip is uncritical. The PSA compound is preferably prepared from the melt compound. In particular, the PSA compound takes the form of a melt during shaping to the web in the bank ahead of the calender nip and also in the calender nip itself. Accordingly, where the compound used for preparing the PSA compound comprises solvent fractions, those fractions are removed from the compound no later than in the bank ahead of the calender nip.

The process for preparing the PSA compound may initially comprise concentrating the poly(meth)acrylate solution or dispersion resulting from polymer preparation. Concentration of the polymer may take place in the absence of crosslinker and accelerator substances. It is also possible, however, for one at most of these substances to be added to the polymer prior to concentration, in which case concentration takes place in the presence of that substance.

The preparing of the PSA compound preferably comprises passage through a compounding and extrusion apparatus. The assembly possibly used for concentrating the compound may or may not be part of this compounding and extrusion apparatus. After passage through the compounding and extrusion apparatus, the PSA compound is preferably in the form of a melt. In particular, the PSA compound is in melt form at the start of the shaping to the web in a calender nip.

The synthetic rubber, optionally together with a poly(meth)acrylate-compatible resin, may be fed into a compounder by way of a solids metering facility. The concentrated and possibly already melted poly(meth)acrylate may be introduced into the compounder via a side feeder. In particular implementations of the process, it is also possible for concentration and compounding to take place in the same reactor. Poly(meth)acrylate-compatible or other resins may optionally also be supplied via a resin melt and a further side feeder elsewhere in the process, such as after the infeed of synthetic rubber and poly(meth)acrylate, for example.

The polyurethane- and/or silicone-based fillers and also further additives and/or plasticizers may likewise be supplied as solids or a melt or else as a batch in combination with another formulation component.

An extruder in particular is used as compounder or as constituent of the compounding and extrusion apparatus. In the compounder, the polymers are preferably present in the melt, either having been fed in already in the melt state or being heated to a melt in the compounder. The polymers in the compounder are advantageously maintained in the melt by heating.

Where accelerator substances are used for crosslinking the poly(meth)acrylate, they are preferably added to the polymers not until shortly before further processing, more particularly shortly before coating or other shaping. The time window for the addition prior to coating is guided in particular by the available pot life, in other words by the working time in the melt without deleterious alteration to the properties of the resultant product.

The crosslinkers, epoxides for example, and optionally the accelerators may also both be added shortly before further processing of the composition, thus advantageously in the phase as set out above for the accelerators. For this purpose it is advantageous if crosslinkers and accelerators are introduced into the operation simultaneously at one and the same location, optionally in the form of an epoxide-accelerator blend. In principle it is also possible to switch the timings and/or locations of addition of crosslinkers and accelerators in the implementations set out above, and so the accelerator may be added before the crosslinker substances.

After the compounding and the delivery of the completed PSA compound, the invention provides for shaping of the PSA compound to the web in a calender nip. The coating calender in this case may consist of two, three, four or more rolls.

Preferably at least one of the rolls is provided with a nonstick roll surface. More preferably, all rolls in the calender that come into contact with the PSA compound are nonstick-furnished. As a nonstick roll surface, preference is given to using a steel-ceramic-silicone composite material. Roll surfaces of these kinds are resistant to thermal and mechanical stresses.

It has emerged as being particularly advantageous to use roll surfaces which have a surface structure, more particularly such that the face does not produce complete contact with the layer of compound being processed, meaning that the contact area is lower as compared with a smooth roll. Particularly favorable are structured rolls such as patterned metal rolls, patterned steel rolls for example.

Coating may take place onto a temporary carrier. A temporary carrier is removed from the layer of adhesive compound in the ongoing processing operation, as for example during the converting of the adhesive tape or during application. The temporary carrier is preferably a release liner. The PSA compound may also be lined on both sides with a temporary carrier or with a release liner, respectively.

In accordance with the invention, the PSA compound is guided through the calender nip such that a bank is formed ahead of said nip. The bank preferably has an extent, at a right angle to the plane subtended by machine direction and calender nip, of 1.0-10 cm.

For the purposes of the invention, there is a temperature difference of at least 5 K between the PSA compound immediately after its preparation, for example after passage through a nozzle, and the bank of PSA compound ahead of the calender nip, with the higher temperature prevailing in the bank. It is presumed that the higher temperature develops in the bank as a result of the flow conditions—swirling, for example.

The preparing of the PSA compound preferably comprises passage through a compounding and extrusion apparatus; the temperature of the PSA compound immediately after exiting the extrusion apparatus, for example after passing through a nozzle, and the temperature of the PSA compound in the bank is higher by at least 10 K, more preferably by at least 15 K, more particularly by at least 20 K than the temperature of the PSA compound immediately after exiting the extrusion apparatus.

With particular preference, therefore, the temperature of the PSA compound in the bank is higher by 10 to 20 K, for an extent of the bank at a right angle to the plane subtended by machine direction and calender nip of 1 to 5 cm, and by 6 to 10 K, for an extent of the bank at a right angle to the plane subtended by machine direction and calender nip of 5 to 10 cm, than the temperature of the PSA compound immediately after exiting the extrusion apparatus.

A further subject of the invention is the use of a web-form PSA compound of the invention or of a web-form PSA compound produced by a process of the invention for bonding components of electronic devices, particularly displays, or components in or on automobiles, more particularly for bonding electronic components in automobiles and for bonding trim strips or emblems on clearcoat finishes of automobiles. Particularly in the context of the bonding of high-value individual parts of electronic devices, such as displays, for example, the possibility of repositioning the components, already outlined above, is particularly advantageous. Bonds using PSA compounds of the invention may be made either manually or with automation.

A subject of the invention, further, is the use of a polyurethane- and/or silicone-based filler, in particular as described above, for boosting the bonding performance of PSA compounds comprising at least one poly(meth)acrylate, preferably also at least one synthetic rubber, and/or for boosting the shock performance of such PSA compounds relative to PSA compounds comprising no polyurethane- and/or silicone-based filler. The boost to bonding performance is ascertained preferably in the form of the instantaneous peel adhesion, measured as described in the examples which follow. The shock performance is ascertained preferably in the form of penetration resistance, measured as described in the examples which follow.

### Examples

Fillers used are available commercially as follows:
Expancel 920DU40 microballoons from Nouyron Chemicals B.V.
Decosphaera 15F polyurethane-based filler from Lamberti S.p.A
ShinEtsu KMP601 silicone-based filler from Shin-Etsu Chemical Co., Ltd.

### Test Methods

### Test 1: Instantaneous Peel Adhesion on Plastic

The determination of the peel adhesion on plastic took place under test conditions of 23° C.+/−1° C. temperature and 50%+/−5% relative humidity, the plastic substrate used being a plate of 30% glass fiber-reinforced PBT with a surface roughness of 1 μm.

For the purpose of cleaning and conditioning prior to measurement, the test plate was first wiped down with ethanol and then left to stand in the air for 5 minutes to allow the solvent to evaporate. The side of the single-layer adhesive tape facing away from the test substrate was then lined with 36 μm etched PET film, to prevent the specimen stretching during the measurement. The test specimen was then rolled down onto the plastic substrate. For this purpose the tape was rolled down back and forth twice using a 2 kg rubber roller at a rolling velocity of 10 m/min. Immediately after it had been rolled down, the adhesive tape was peeled off from the plastic substrate at an angle of 180°, and the force required to achieve this was measured with a Zwick tensile testing machine. The measurement results are reported in N/cm and are averaged from three individual measurements.

A good result is regarded as a peel adhesion of 3.0 N/cm or more.

### Test 2: Drop Tower Test Method (Penetration Resistance)

A square sample in the shape of a frame was cut from the adhesive tape under investigation (area 180 mm²; border width 2.0 mm).

This sample was adhered to a steel frame which had been cleaned with acetone and primed*. On the other side of the adhesive tape a steel window cleaned with acetone and primed* was stuck. The bonding of steel frame, adhesive tape frame and steel window took place in such a way that the geometric centers and the diagonals were each superimposed on one another (corner to corner). The bond was subjected to pressure at 62 N for 10 s and was stored for 24 h with conditioning at 23° C./50% relative humidity.

*Primer application: the primer was applied using a primer pen with subsequent further conditioning of the substrates for 30 min at 23° C./50% r.h.

The test specimen was inserted in the sample holder of the instrumented drop apparatus in such a way that the assembly was horizontal, with the steel window oriented downward. The measurement took place by instrument and automatically, using a loading weight of 5 kg and a drop height of 20 cm. The kinetic energy introduced by the loading weight destroyed the adhesive bond, by fracture of the adhesive tape between window and frame, and the force was recorded every μs by a piezoelectric sensor. The associated software accordingly gave the graph for the force/time progression after the measurement, and from this it was possible to determine the maximum force Fmax. Shortly before the impact of the rectangular impact geometry on the window, the velocity of the falling weight was determined using two light beams. On the assumption that the energy introduced is large relative to the impact resistance of the adhesive bond, the force progression, the time taken for detachment, and the velocity of the falling weight were used to ascertain the work performed by the bond before complete detachment, i.e., the detachment work. Five test specimens of each sample were investigated; the final impact resistance result consists of the average of the detachment work (energy in J) or the maximum force (Fmax in N) for these five samples.

### General Experimental Description: Preparation of the PSA Compounds

### Preparation of the Polyacrylate:

A reactor conventional for radical polymerizations was charged with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through the reactor for 45 minutes, with stirring, the reactor was heated to 58° C. and 50 g of AIBN in solution in 500 g of acetone were added. The external heating bath was then heated to 75° C. and the reaction was carried out constantly at this external temperature. After 1 h a further 50 g of AIBN in solution in 500 g of acetone were added, and after 4 h the reaction mixture was diluted with 10 kg of acetone/isopropanol mixture (94:6).

After 5 h and again after 7 h, the reaction was reinitiated with in each case 150 g of bis(4-tert-butylcyclohexyl) peroxydicarbonate in each case in solution in 500 g of acetone. After a reaction time of 22 h, the polymerization was terminated and the system was cooled to room temperature. The product had a solids content of 55.8% and was dried.

### General Preparation Process for the Examples:

The synthetic rubber Europrene SOLT190 in pellet form was melted in a planetary roller extruder via a solids metering facility. Added subsequently were the polyacrylate premelted and concentrated in a single-screw extruder, the acrylate resin Paraloid™ DM55, the filler and a color paste (Levanyl® N-FL). A crosslinker (Uvacure® 1500) as well was added to the mixture. The melt was mixed and shaped via a double-roll calender between two release films (siliconized PET film) into a layer having a thickness of 200 μm.

The composition of the resultant layers of adhesive was as follows: 50% by weight polyacrylate, 35% by weight Europrene SOLT190, 13% by weight Paraloid™ DM55, 0.5% by weight crosslinker, 1.5% color paste; additionally to the base composition, x % by weight (see Table 1) PU- or silicone-based filler.

### Preparation Process, Comparative Example

The synthetic rubber Europrene SOLT190 in pellet form was melted in a planetary roller extruder via a solids metering facility. Added subsequently were the polyacrylate premelted and concentrated in a single-screw extruder, the acrylate resin Paraloid™ DM55, the microballoons (Expancel® 920DU40: Nouryon) and a color paste (Levanyl® N-FL). A crosslinker (Uvacure® 1500) as well was added to the mixture. The melt was mixed and shaped via a double-roll calender between two release films (siliconized PET film) into a layer having a thickness of 200 μm.

TABLE 1
Compositions and test results

| | | | | Instan- | |
|---|---|---|---|---|---|
| | | | | taneous | Drop tower |
| | | | | peel | test |
| | | Amount | | adhesion | Energy (J)/ |
| | | of filler | | on | Fmax |
| Experi- | Filler | % by | Density | plastic | (N)/Failure |
| ment | Name | wt. | kg/m³ | N/cm | mode |
| C. Ex. 1 | Expancel | 1.2 | 921 | 0.52 | 1.08/1558/f.s. |
| | 920DU40 | | | | |
| Ex. 1 | Decosphaera 15F | 3 | 1027 | 4.41 | 1.48/1909/c.f. |
| Ex. 2 | Decosphaera 15F | 5 | ~1030 | 3.38 | 1.47/2050/c.f. |
| Ex. 3 | Decosphaera 30F | 7 | ~1030 | 4.15 | 1.47/2014/c.f. |
| Ex. 4 | ShinEtsu KMP601 | 3 | 1026 | 3.79 | 1.37/1801/c.f. |
| Ex. 5 | ShinEtsu KMP601 | 5 | 1034 | 3.24 | 1.72/1810/c.f. |

C. Ex. = comparative example;
Ex. = example;
c.f. = cohesive fracture,
f.s. = foam splitting

A significant boosting of the instantaneous peel adhesion on plastic was observable through use of polyurethane- or silicone-based fillers. Similarly, it was possible to boost the bonding performance under high-frequency loading (drop tower test). Both the maximum force for the parting of the bond and the necessary energy for the parting of the bond could be increased here.

1. A web-form pressure sensitive adhesive (PSA) compound comprising
at least one poly(meth)acrylate and
at least one polyurethane- and/or silicone-based filler.

2. The web-form PSA compound as claimed in claim 1, wherein
the at least one polyurethane-based filler comprises or consists of polyurethane beads and/or in that the at least one silicone-based filler comprises or consists of silicone beads.

3. The web-form PSA compound as claimed in claim 2, wherein the beads have a mean particle size d(50) of 1 to 80 μm and/or have a bulk density of 300 to 800 g/L.

4. The web-form PSA compound as claimed in claim 1, wherein the at least one polyurethane- and/or silicone-based filler is comprised at 0.1 to 10% by weight, based on a total weight of the PSA compound.

5. The web-form PSA compound as claimed in claim 1, wherein a thickness of the web-form PSA compound is 50-1500 μm and/or a density of the web-form PSA compound is at least 800 kg/m³.

6. The web-form PSA compound as claimed in claim 1, wherein the PSA compound comprises at least one synthetic rubber.

7. The web-form PSA compound as claimed in claim 6, wherein the PSA compound comprises
40-70% by weight of the at least one poly(meth)acrylate and
15-50% by weight of the at least one synthetic rubber,
based in each case on a total weight of the PSA compound.

8. The web-form PSA compound as claimed in claim 1, wherein the PSA compound comprises at least one tackifier.

9. The web-form PSA compound as claimed in claim 6, wherein the synthetic rubber is a block copolymer having a structure A-B, A-B-A, (A-B)ₙ, (A-B)ₙX or (A-B-A)ₙX,
in which
the blocks A independently of one another are a polymer formed by polymerization of at least one vinyl aromatic;
the blocks B independently of one another are a polymer formed by polymerization of conjugated dienes having 4 to 18 C atoms and/or isobutylene, or are a partially or fully hydrogenated derivative of such a polymer;
X is the radical of a coupling reagent or initiator, and
n is an integer 2 2.

10. A process for preparing a web-form PSA compound as claimed in claim 1, comprising
a) preparing a PSA compound comprising
at least one poly(meth)acrylate and
at least one polyurethane- and/or silicone-based filler;
b) shaping the PSA compound to the web in a calender nip,
where the PSA compound is guided through the calender nip such that a bank is formed ahead of the calender nip, and
the temperature of the PSA compound in the bank is at least 5 K more than the temperature of the PSA compound immediately after its preparation.

11. The process as claimed in claim 10, wherein the process is a continuous process.

12. The process as claimed in claim 10, wherein
the preparing of the PSA compound comprises passage through a compounding and extrusion apparatus; and
the temperature of the PSA compound in the bank is at least 5 K more than the temperature of the PSA compound immediately after exiting the extrusion apparatus.

13. A method comprising bonding components of electronic devices or components in automobiles with a web-form PSA compound as claimed in claim 1.

14. A method of boosting the bonding performance of PSA compounds comprising at least one poly(meth)acrylate and/or for boosting the shock performance of such PSA compounds relative to PSA compounds comprising no polyurethane- and/or silicone-based filler, said method comprising incorporating into said PSA compounds a polyurethane- and/or silicone-based filler.
